(19) United States
(12) Patent Application Publication
(10) Pub. No.: US 2011/0010622 A1
(43) Pub. Date: Jan. 13, 2011

(54) Touch Activated Display Data Entry

(76) Inventor: Chee Keat Fong, Houston, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/919,552

(22) PCT Filed: Apr. 29, 2008
(86) PCT No.: PCT/US08/61839

§ 371 Date: Aug. 26, 2010

(51) Int. Cl. G06F 3/041; G06F 3/01

(52) U.S. Cl. 715/702; 345/173

(57) ABSTRACT

Systems, methods, and other embodiments associated with touch activated display (TAD) data entry are described. An example apparatus displays a first set of touch selected virtual keypad elements (TSVKEs). A member of the first set of TSVKEs includes a subset of a set of symbols. A first member of the first set of TSVKEs is selected by touching the TAD at a first location associated with the first member. The apparatus also displays a second set of TSVKEs that depends on the first member. A member of the second set of TSVKEs displays a subset of symbols displayed by the first member. In response to a selection, the apparatus also provides a symbol associated with a second member selected from the second set of TSVKEs to a processor.

### BACKGROUND

Hand held computing devices are ubiquitous. Common handheld computing devices include, personal digital assistants (PDA), cellular telephones, music players (e.g., MP3 player), movie players (e.g., MPEG player), personal game systems, and so on. These handheld computing devices may run a variety of applications including image viewing programs, word processors, video games, telephony, email, and so on. These handheld computing devices may include a variety of well known input controls suited to their applications. For example, handheld computing devices may include keypads, touch sensors, buttons, wheels, sliders, and so on. Furthermore, these input devices may be both physical (e.g., keypad with fixed, physical buttons) or virtual (e.g., virtual keypads with keys displayed on touch activated display). Thus, numerous combinations of input devices and applications are available. However, interesting combinations of input devices and applications continue to arise.

User interface input devices for computing devices are also ubiquitous. A mouse, a keyboard and a touch activated display (TAD) are common examples of user interface input devices. In the past, tiny mechanical keyboards have been used with small personal devices such as PDAs. Virtual keypads have also been used to allow for data entry without the need for a dedicated keyboard on the device. Virtual keypads display the keyboard on the TAD. These keys are touched by the user and the touch location is sensed by the TAD. An issue with both mechanical and virtual keyboards is that the tiny keys are usually difficult to activate with the finger, and almost impossible to activate with the thumb. In addition, character recognition of characters drawn by the user without the use of a stylus is difficult due to the limited dexterity of the fingers or thumbs.

Difficulties in activating tiny keypads, whether mechanical or virtual, have spawned other solutions including keypads that automatically correct the frequent mistakes made by the user attempting to touch small target keys. These mistakes are corrected by guessing what the user wants to type by using a dictionary look-up. This approach does not work well for URLs, names, addresses and other words not commonly found in the dictionary.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIGS. 1a, 1b, 1c, and 1d illustrate example embodiments associated with using composite buttons on a hand held computing device utilizing a TAD.

FIG. 2 illustrates an example method associated with displaying and selecting two sets of user selectable graphical user interface elements (USGUIEs).

FIG. 3 illustrates another example method associated with displaying and selecting two sets of user selectable graphical user interface elements (USGUIEs).

FIG. 4 illustrates an example system associated with displaying and selecting a set of touch selected virtual keypad elements (TSKVEs).

FIG. 5 illustrates an example computing environment in which example systems and methods, and equivalents, may operate.

FIG. 6 illustrates an example of how intermittent contact with a touch screen may occur and/or be processed.

### DETAILED DESCRIPTION

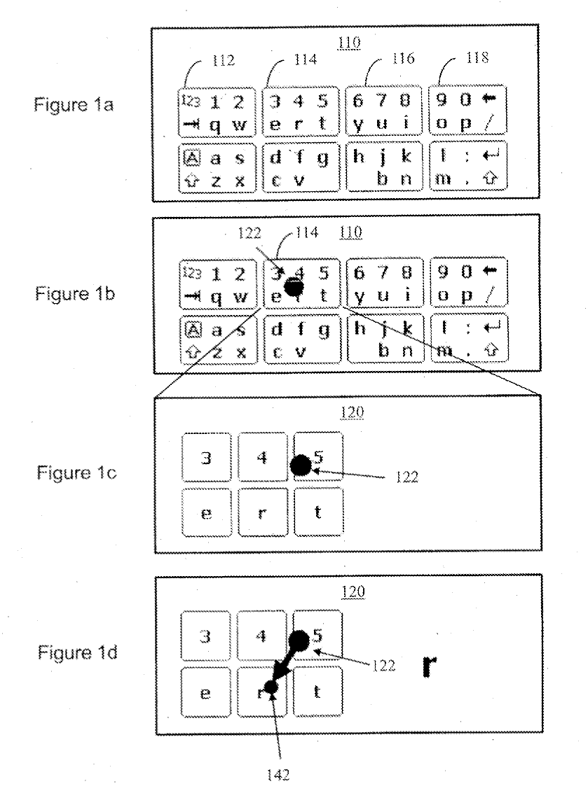

FIGS. 1a, 1b, 1c, and 1d illustrate example displays of a virtual keypad 110 displayed upon and sensed by a touch activated display (TAD). The TAD may be a resistive TAD, a capacitive TAD, a surface acoustic wave TAD, an infrared TAD, a strain gauge TAD, an optical imaging TAD, a dispersive signal technology TAD, an acoustic pulse recognition TAD, a frustrated total internal reflection TAD, and so on. A TAD is configured to sense touches on the virtual keypad 110 from a finger, a thumb, a styli or other pointing object. Conventional virtual keypads may have included many tiny keys packed together in a small area. Instead of the tiny keys, a similar area on virtual keypad 110 displays composite buttons (e.g. 112, 114, 116, and 118). The composite buttons are comparatively larger in size, but smaller in number. A composite button may be sized large enough for a thumb to accurately touch. A single composite button includes multiple symbols inside of its boundaries. For example, composite button 114 includes characters 3, 4, 5, e, r, and t. Thus each composite button is generated and displayed to represent multiple characters.

FIGS. 1a and 1b depict the virtual keypad 110 in two states. FIG. 1a shows an unselected state (without a black dot 122) prior to the keypad being touched. FIG. 1b represents a selected state when the virtual keypad 110 is selected with a touch 122 on composite button 114. The black dot represents the location of the touch 122.

When the user selects a composite button with a touch, the virtual keypad morphs to display a group of individual symbol buttons on a new virtual keypad 120 (see FIG. 1c). The touch 122 on the virtual keypad 110 in the selected state of FIG. 1b is also seen In the virtual keypad 120 in FIG. 1c. The touch 122 does not yet select the individual symbol button at that location on virtual keypad 120. Touch 122 is the touch that selects the composite button in virtual keyboard 110, causes the virtual keyboard 110 to display the new virtual keyboard 120 with the individual symbol buttons from the selected composite button 114 to be displayed in a larger form. The other non-selected composite buttons may disappear or remain in the background as the new individual, symbol buttons appear. Additionally, the other non-selected composite buttons may remain while the individual symbol buttons appear on a different section of the TAD.

With reference to FIG. 1c, the new individual symbol buttons displayed on the virtual keypad 120 may have individual symbols within their boundaries, where the symbols come from the selected composite button. For example, if a user selects a composite button with six symbols, six individual symbol buttons with the same symbols appear after the composite button is selected. The individual buttons are now individually selectable. The individual buttons could appear in a cluster that would be logically placed, relative to their displayed position within the composite button. For example, the layout of the characters in the individual symbol buttons in virtual keyboard 120 is similar to the layout of the symbols within the composite button 114 in virtual keyboard 110. This logical placement makes it more intuitive for the user to locate the correct symbol.

After touching the composite button 114 at location 122 on virtual keypad 110, the screen may morph to show the individual symbol buttons in virtual keypad 120. FIG. 1d represents the virtual keypad 120 in a selected state where the user selects a desired individual symbol button by dragging the finger, thumb, styli or other pointing object on the virtual keypad 120 from location 122 to location 142. In the example, location 142 is the location of the desired individual symbol button “r.” Releasing the touching member from the virtual keypad 120 at location 142 causes the symbol “r” to be selected and sent to the processor as an input. After the selection, the virtual keypad 120 may revert to displaying the composite buttons as in virtual keypad 110 of FIG. 1a. By defining and displaying a virtual keypad using composite symbols, a user can touch a large area of a composite button to preliminarily select a group of characters. Then the group of characters are individually re-displayed in a larger form and are now individually selectable by dragging the finger or thumb to the desired character and then to release. The user effectively draws a short line with their finger to enter a symbol and the device is programmed to detect such movement.

In another example, the user may use a double tap method, where both the composite button and individual symbol button are tapped and released, causing the symbol to be sent to the processor. Unlike previous tiny mechanical keyboards and virtual keypads utilizing tiny buttons, virtual keypads 110 and 120 may use individual buttons that are large enough to be easily and accurately activated with a finger or thumb.

Although the example embodiments above are recognized for use with small touch activated displays located on personal digital assistants (PDAs) and cellular telephones; the examples can also be applied to larger devices utilizing TADs. In one example, workers may wear thick protective gloves. Thus, a composite button virtual keypad could be implemented on a fixed location TAD to increase accuracy and speed in data entry without necessitating the installation of a dedicated keyboard.

The following includes definitions of selected terms employed herein. The definitions include various examples and/or forms of components that fall within the scope of a term and that- may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

PCI: peripheral component interconnect.

PCIE: PCI express.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

TAD: Touch Activated Display.

USGUIEs: User Selectable Graphical User Interface Elements.

TSVKEs: Touch Selected Virtual Keypad Elements.

“Computer component”, as used herein, refers to a computer-related entity (e.g., hardware, firmware, software in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium”, as used herein, refers to a medium that stores signals, instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

“User”, as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

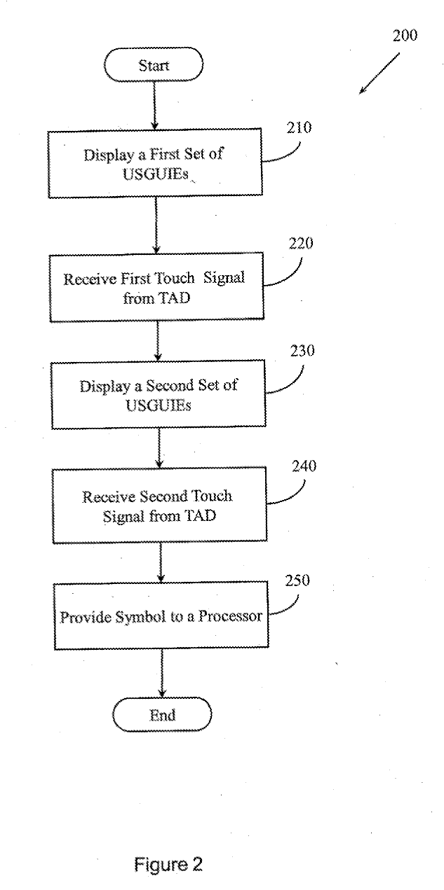

FIG. 2 illustrates an example method 200 associated with displaying and selecting multiple sets of user selectable graphical user interface elements (USGUIEs) on a TAD. The USGUIEs may be displayed on a hand held computing device or another computing device that includes a TAD. Method 200 may include, at 210, displaying a first set of USGUIES on the TAD. The first set of USGUIES may be a set of symbols. The set of symbols may include, for example, characters from the English alphabet, characters associated with a QWERTY keyboard, and so on. A member of the first set of USGUIEs may be a subset of the set of symbols displayed by the first set of USGUIEs. For example, the set of symbols may be the letters a-z. The member, being a subset of the set of symbols, may display the letters a-d, while another member may display e-h. Example USGUIEs are illustrated in FIG. 1a as composite buttons 112, 114, 116, 118 where each button is defined and generated to represent multiple characters. For example virtual keyboard 110 illustrates eight user selectable elements (e.g. buttons) that display the set of symbols of a QWERTY keypad.

Method 200 may also include, at 220, receiving a first touch signal from the TAD. The first touch signal identifies a member of the first set of USGUIEs. The first member is selected in response to an object (e.g. a touching member) touching the TAD at a first location. The touch may be, for example, a touch by a finger or a thumb on the surface of the TAD at the location of the first member.

In response to the first member being selected, a second set of USGUIEs is displayed (at 230). The second set of USGUIES depends, at least in part, upon the first touch signal 220 received from the TAD. For example in FIG. 1c, the individual buttons in virtual keyboard 120 may depend upon the selected composite button 114 in virtual keypad 110 of FIG. 1a. In the example, the selected composite button is shown with a black dot 112 that identifies a touch location. The selected composite button 114 includes characters 3, 4, 5, e, r, and t. The individual buttons in virtual keyboard 120 contain the same characters or a subset of the characters of the composite button. In another example, the second set of USGUIEs may include an incomplete subset of the set of symbols displayed by the first set of USGUIEs and a set of characters not included in the set of symbols displayed by the first set of USGUIEs. In still another example, the second set of USGUIEs may be an incomplete subset of the set of symbols displayed by the first set of USGUIEs.

Method 200 may also include, at 240, receiving a second touch signal from the TAD with respect to the second set of USGUIEs. The second touch signal identifies a second member of the second set of USGUIES. Selection of the second member may be performed in response to moving the touching member from the first location to a second location. The second location is associated with the second member. The selection occurs upon lifting the touching member from the TAD. For example, selection of the second member is illustrated in FIG. 1d by the virtual keypad 120 in the selected state by the drag and release from location 122 to location 142. The method is configured to detect the movement of the touching member on the TAD, which can move in manners including, for example, dragging the touching member along the TAD while maintaining constant contact, substantially constant contact, or intermittent contact with the TAD. Intermittent contact is loss of contact with the TAD for about than 10 milliseconds or less. The movement of the touching member from the first location to the second location may also include the use of a double tap. For example touching the touching member at the first location followed by lifting from the first location and then touching the touching member at the second location and then lifting.

Method 200 may also include, at 250, providing a symbol to a processor. The symbol is the symbol identified by the second touch signal from the TAD. Providing the symbol may include, for example, passing the symbol as an electronic signal to a processor similar to a conventional mechanical keyboard passing a character signal to a processor.

While FIG. 2 illustrates various actions occurring in serial, it is to be appreciated that various actions illustrated in FIG. 2 could occur substantially in parallel. By way of illustration, a first process could display a second set of USGUIEs, a second process could receive a second touch signal, and a third process could provide a symbol to a processor. While three processes are described, it is to be appreciated that a greater and/or lesser number of processes could be employed and that lightweight processes, regular processes, threads, and other approaches could be employed.

In one example, a method may be implemented as computer executable instructions. Thus, in one example, a computer-readable medium may store computer executable instructions that if executed by a machine (e.g., processor) cause the machine to perform method 200. While executable instructions associated with method 200 are described as being stored on a computer-readable medium, it is to be appreciated that executable instructions associated with other example methods described herein may also be stored on a computer-readable medium.

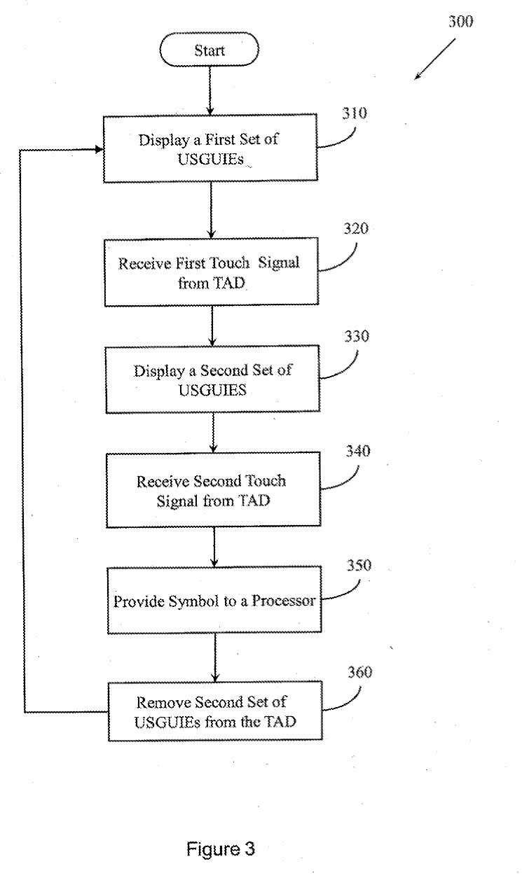

FIG. 3 illustrates an example method 300 associated with displaying multiple sets of USGUIEs on a TAD and selecting a single USGUIE. Method 300 includes some actions similar to those described in connection with method 200 (FIG. 2). For example, method 300 includes displaying a first set of USGUIEs at 310, receiving a first touch signal from the TAD at 320, displaying a second set of USGUIES at 330, receiving a second touch signal from the TAD at 340, and providing a symbol to a processor at 350. However, method 300 includes additional actions.

For example, method 300 includes, at 360, removing the second set of USGUIEs from the TAD. The removing includes, for example, fading the image, wiping the image, morphing the image, immediately clearing the image from the TAD, and so on. Method 300 may also include returning to 310 to “re-display” the first set of USGUIEs on the TAD.

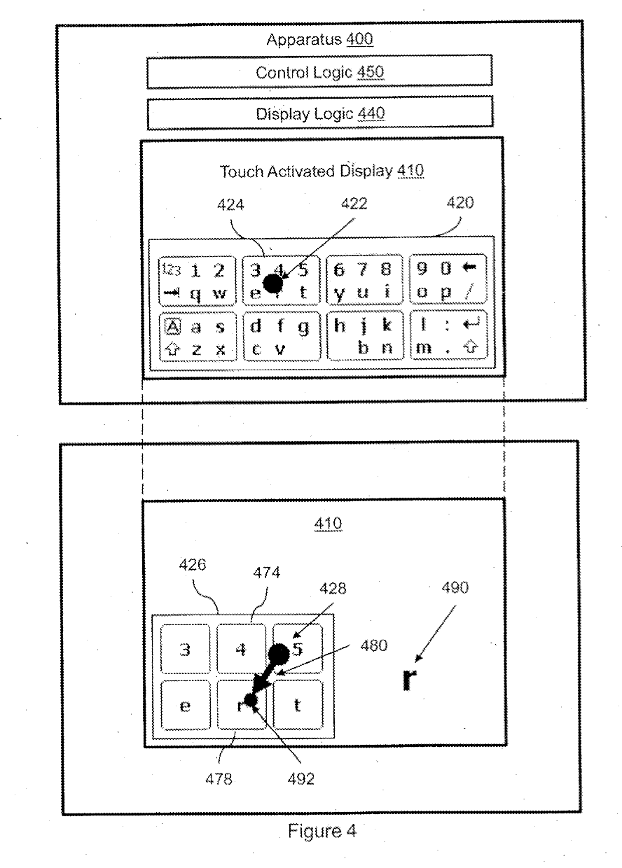

FIG. 4 illustrates an apparatus 400 associated with displaying multiple sets of touch selected virtual keypad elements (TSVKEs) on a touch activated display (TAD) and selecting one TSVKE. Apparatus 400 includes a TAD 410 for providing a touch signal associated with a touch by a touching member. The touch may occur at location 422. The TAD 410 may be for example a resistive TAD, a capacitive TAD, a surface acoustic wave TAD, an infrared TAD, a strain gauge TAD, an optical imaging TAD, a dispersive signal technology TAD, an acoustic pulse recognition TAD, and a frustrated total internal reflection TAD. The apparatus 400 may be, for example, a personal digital assistant, a cellular phone, a fixed location computer with a touch screen, and so on. Therefore, apparatus 400 may run applications like a word processor, a spreadsheet, a database program, and so on.

Apparatus 400 may also include a display logic 440 to control the TAD to display a first set of TSVKEs 420. A member 424 of the first set of the TSVKEs 420 may include a subset of the set of symbols in the first set of TSVKEs. The first set of TSVKEs 420 may be, for example, eight separate keys. The first set of TSVKEs may include, for example, the set of symbols of a QWERTY keyboard arranged in the format of a QWERTY keyboard. The member 424 of the first set of TSVKEs is shown to contain a subset of the set of symbols. For example, the member 424 includes 3, 4, 5, e, r, and t as the subset of the QWERTY keyboard.

Apparatus 400 may also a include control logic 450 to receive touch signals from the TAD 410. An example touch may occur at a first location 422. An initiation touch signal identifies a first member of the set of TSVKEs. The first member is selected in response to the touching member touching the TAD at the first location 422. For example, the touch at the first location 422 may identify a member 424 of the first set of TSVKEs 424 that includes the characters 3, 4, 5, e, r, and t.

The control logic 450 may display a second set of TSVKEs 426 in response to receiving the initiation touch signal from the TAD 410. A member 474 of the second set of TSVKEs displays a subset of characters displayed by the first member 424. The member 474 may display the subset by displaying the single character “4,” however multiple characters may also be displayed by individual members of the second set of TSVKEs. A third set of TSVKEs could also be displayed in response to the selection of a member of the second set of TSVKEs.

Control logic 450 may provide a symbol 490 to a processor in response to receiving a terminating touch signal 480. The terminating touch, signal 480 identifies a second member 478 of the second set of TSVKEs 426. The second member, identified by the terminating touch signal 480, is selected in response to moving the touching member from the first location 428 to a second location 492, shown as the termination touch signal 480. The first location 428 of the termination touch signal 480 may correspond to the first location 422.

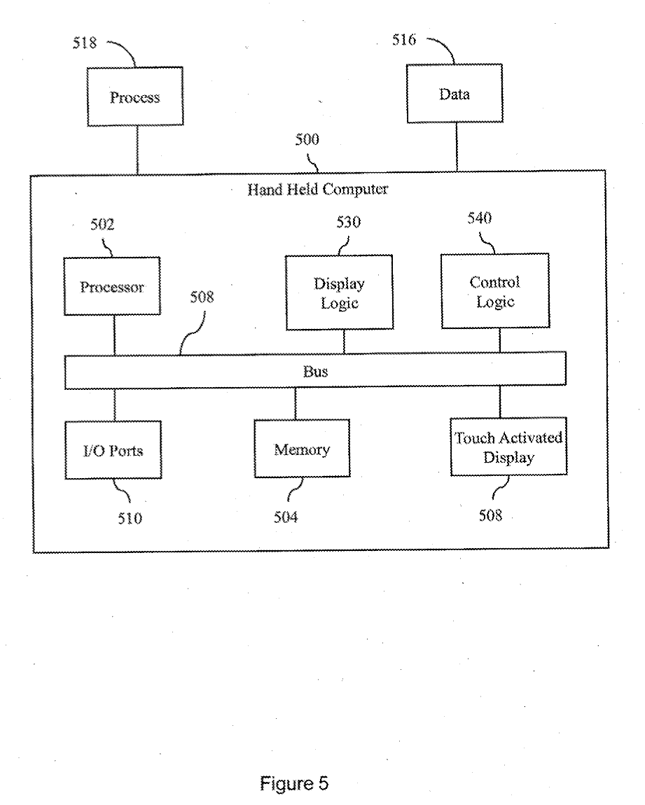

FIG. 5 illustrates an example computing device in which example systems and methods described herein, and equivalents, may operate. The example computing device may be a hand held computer 500 that includes a processor 502, a memory 504, TAD 508, and input/output ports 510 operably connected by a bus 508. As described, the TAD may be a resistive TAD, a capacitive TAD, and so on.

In one example the hand held computer 500 may include a display logic 530 to control the TAD 508. In different examples, the display logic 530 may be implemented in hardware, software, firmware, and/or combinations thereof to perform its functions. While the display logic 530 is illustrated as a hardware component attached to the bus 508, it is to be appreciated that in one example, the display logic 530 could be implemented in the processor 502.

Display logic 530 and TAD 508 can be implemented in a variety of means (e.g., hardware, software, firmware) for controlling a first set of touch selected symbols (TSS) displayed on a TAD. The first set of TSS may be displayed on the TAD 508. The display logic 530 may be implemented, for example, as an ASIC programmed to receive and process the signal. The display logic 530 may also be implemented as computer executable instructions that are presented to hand held computer 500 as data 516 that are temporarily stored in memory 504 and then executed by processor 502.

In another example the hand held computer 500 may include a control logic 540 to receive signals from and to control the TAD 508. In different examples, the control logic 540 may be implemented in hardware, software, firmware, and/or combinations thereof to perform its functions. While the control logic 540 is illustrated as a hardware component attached to the bus 508, it is to be appreciated that in one example, the control logic 540 could be implemented in the processor 502.

Control logic 540 can be implemented in a variety of means (e.g. hardware, software, firmware) for controlling a second set of TSS, including how they are displayed on the TAD 508. The second set of TSS may be displayed on the TAD 508. Control logic 540 may also control displaying a single symbol, where the single symbol is a member of the first set of TSS. The first member may be selected by a first touch at a first location on the TAD 508. Control logic 540 may be implemented, for example, as an ASIC programmed to receive and process the signal. Control logic 540 may also be implemented as computer executable instructions that are presented to the hand held computer 500 as data 516 or a process 518 that are temporarily stored in memory 504 and then executed by processor 502.

Control logic 540 can further be implemented with means (e.g., hardware, software, firmware) for providing a symbol associated with a second member to a processor. The second member may be selected in response to moving a touching member from the first location to a second location on the TAD 508. The selection of the second member may occur upon lifting the touching member from the second location. The second location may be associated with the second member. The control logic 540 may be implemented, for example, as an ASIC programmed to receive and process the signal. The means may also be implemented as computer executable instructions that are presented to hand held computer 500 as data 516 that are temporarily stored in memory 504 and then executed by processor 502.

In the different examples, the control logic 540 may be implemented in hardware, software, firmware, and/or combinations thereof. While the control logic 540 is illustrated as a hardware component attached to the bus 508, it is to be appreciated that in one example, the control logic 540 could be implemented in the processor 502.

Generally describing an example configuration of the hand held computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

The bus 508 may be a single internal bus interconnect architecture and/or other bus or mesh architectures. While a single bus is illustrated, it is to be appreciated that the hand held computer 500 may communicate with various devices, logics, and peripherals using other busses (e.g., PCIE, 1394, USB, Ethernet). The bus 508 can be types including, for example, a memory bus, a memory controller, a peripheral bus, an external bus, a crossbar switch, and/or a local bus.

The hand held computer 500 may interact with input/output devices via input/output ports 510. Input/output devices may be, for example, a keyboard, a microphone, a pointing and selection device, cameras, video cards, displays, the disks, network devices, and so on. The input/output ports 510 may include, for example, serial ports, parallel ports, and USB ports.

The hand held computer 500 can operate in a network environment and thus may be connected to network devices via i/o interface, and/or the i/o ports 510. Through network devices, the hand held computer 500 may interact with a network. Through the network, the hand held computer 500 may be logically connected to remote computers. Networks with which the hand held computer 500 may interact include, but are not limited to, a LAN, a WAN, and other networks.

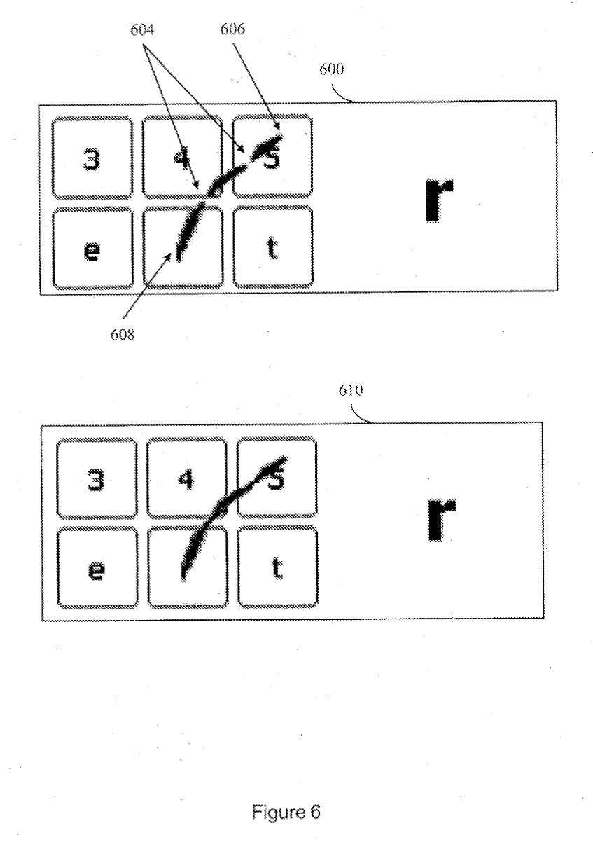

FIG. 6 illustrates how intermittent contact may occur and/or be processed by a TAD, processor, display logic, control logic, and so on. When dragging a finger or thumb across a touch activated device, it is not uncommon for the touch pressure to change and cause an intermittent loss of contact. For example virtual keypad 600 illustrates how intermittent, contact may appear to the processor when dragging a finger or thumb from location 606 to 608. Breaks in contact with the TAD are illustrated by gaps 604. The processor may filter out spurious breaks that would otherwise cause unwanted characters to appear. For example the filter may fill in the gaps as shown in filtered virtual keypad 610.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Gamer, A Dictionary of Modem Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC; BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A computer-readable medium storing computer-executable instructions that when executed by a computer cause the computer to perform a method, the method, comprising:
displaying a first set of user selectable graphical user interface elements (USGUIEs) on a touch activated display (TAD), where the first set of USGUIEs displays a set of symbols, and where a member of the first set of USGUIEs displays a subset of the set of symbols;
receiving a first signal from the TAD, where the first signal identifies a first member of the first set of USGUIEs, where the first member is selected in response to detecting a touch of a touching member on the TAD at a first location associated with the first member;
displaying a second set of USGUIEs in response to receiving the first signal, where the second set of USGUIEs depends, at least in part, on the first signal, and where a member of the second set of USGUIEs displays a subset of characters displayed by the first member of the first set of USGUIEs;
receiving a second signal from the TAD, where the second signal identifies a second member of the second set of USGUIEs, where the second member is selected in response to detecting a movement of the touching member from the first location to a second location associated with the second member and then detecting a lifting of the touching member from the TAD; and
providing a symbol identified by the second signal to a processor.

2. The computer-readable medium of claim 1, where the first set of USGUIEs includes characters from the English alphabet.

3. The computer-readable medium of claim 1, where the first set of USGUIEs includes characters associated with a QWERTY keyboard.

4. The computer-readable medium of claim 1, where the TAD is one of, a resistive TAD, and a capacitive TAD.

5. The computer-readable medium of claim 1, where the TAD is one of, a surface acoustic wave TAD, an infrared TAD, a strain gauge TAD, an optical imaging TAD, a dispersive signal technology TAD, an acoustic pulse recognition TAD, and a frustrated total internal reflection TAD.

6. The computer-readable medium of claim 1, where the second set of USGUIEs is an incomplete subset of the set of symbols displayed by the first set of USGUIEs.

7. The computer-readable medium of claim 1, where the second set of USGUIEs includes an incomplete subset of the set of symbols displayed by the first set of USGUIEs and a set of characters not included in the set of symbols displayed by the first set of USGUIEs.

8. The computer-readable medium of claim 1, where detecting the movement of the touching member from the first location to the second location includes detecting a dragging of the touching member along the TAD while maintaining constant contact with the touch activated display.

9. The computer-readable medium of claim 1, where detecting the movement of the touching member from the first location to the second location includes detecting a dragging of the touching member along the TAD while maintaining substantially constant contact with the touch activated display.

10. The computer-readable medium of claim 1, where detecting the movement of the touching member from the first location to the second location includes detecting a dragging of the touching member along the TAD with loss of contact with the touch activated display of about 10 milliseconds or less.

11. The computer-readable medium of claim 1, where detecting the movement of the touching member from the first location to the second location includes detecting a lifting of the touching member from the first location and detecting a touching of the touching member at the second location.

12. The computer-readable medium of claim 1, where detecting a touch of a touching member includes detecting a touch of a finger, thumb, or styli.

13. The computer-readable medium of claim 1, where in response to receiving a second signal from the TAD, the second set of USGUIEs are removed from the TAD and the first set of USGUIEs are re-displayed on the TAD.

14. An apparatus, comprising:
a touch activated display (TAD) including a display and a touch signal sensor to detect a touch by a touching member, where the TAD is to provide a touch signal upon detecting the touch by the touching member,
a display logic to control the TAD to display a first set of touch selected virtual keypad elements (TSVKEs), where a member of the first set of TSVKEs includes a subset of a set of symbols; and
a control logic to receive touch signals from the TAD, and
in response to receiving an initiation touch signal from the TAD, to control the TAD to display a second set of TSVKEs, where the initiation touch signal identifies a first member of the first set of TSVKEs, where the first member is selected in response to the touching member touching the TAD at a first location associated with the first member, where the second set of TSVKEs depends, at least in part, on the initiation touch signal and the first set of TSVKEs, and where a member of the second set of TSVKEs displays a subset of symbols displayed by the first member of the first set of TSVKEs, and
in response to receiving a terminating touch signal from the TAD, to provide a symbol to a processor, where the terminating touch signal identifies a symbol associated with a second member of the second set of TSVKEs, and where the second member is selected in response to moving the touching member from the first location to a second location associated with the second member and then lifting the touching member from the TAD.

15. The apparatus of claim 14, where the apparatus is a hand held computer.

16. The apparatus of claim 14, where the apparatus is one of, a cellular phone, and a personal digital assistant.

17. The apparatus of claim 14, where the control logic controls the TAD to re-display the first set of TSVKEs in, response to receiving the terminating touch signal.

18. The apparatus of claim 14, where the TAD is one of, a surface acoustic wave TAD, an infrared TAD, a strain gauge TAD, an optical imaging TAD, a dispersive signal technology TAD, an acoustic pulse recognition TAD, and a frustrated total internal reflection TAD.

19. The apparatus of claim 14, where the touch signal sensor is configured to detect the touch of a finger, thumb, or styli.

20. The apparatus of claim 14, where the first set of TSVKEs is one of, a set of characters from the English alphabet, and a set of characters associated with a QWERTY keyboard.

21. The apparatus of claim 14, where the control logic is configured to detect movement of the touching member from the first location to the second location where the movement includes sliding the touching member along the TAD while maintaining constant contact with the touch activated display.

22. The apparatus of claim 14, where the control logic is configured to detect movement of the touching member from the first location to the second location where the movement includes sliding the touching member along the TAD while maintaining substantially constant contact with the touch activated display.

23. The apparatus of claim 14, where moving the touching member from the first location to the second location includes sliding the touching member along the touch activated display with loss of contact with the TAD of about 10 milliseconds or less.

24. A system, comprising:
means for controlling subsets of a first set of touch selected symbols (TSS) displayed on a touch activated display (TAD);
means for controlling a second set of TSS that display a symbol, where the symbol displayed by a member of the second set of TSS is one of the subset symbols displayed by a first member of the first set of TSS, where the first member is selected by a touch at a first location on the TAD; and
means for providing a symbol associated with a second member to a processor, where the second member is selected in response to sensing movement of a touching member on the TAD from the first location to a second location associated with the second member.

25. The system of claim 24, where providing a symbol includes moving a touching member from the first location to second location and lifting the touching member from the second location.
